(19) United States
(12) Patent Application Publication
(10) Pub. No.: US 2026/0307438 A1
(43) Pub. Date: Oct. 8, 2026

(54) Jack Support Apparatus

(71) Applicant: Larry Reed, Sun City, AZ (US)

(72) Inventor: Larry Reed, Sun City, AZ (US)

(21) Appl. No.: 19/443,124

(22) Filed: Jan. 8, 2026

Related U.S. Application Data
(60) Provisional application No. 63/785,048, filed on Apr. 8, 2025.

(51) Int. Cl. B60D 1/66; B60S 9/02

(52) U.S. Cl. CPC B60D 1/66; B60S 9/02

(57) ABSTRACT

A trailer-mounted (i.e., mountable) jack support apparatus for stabilizing a trailer jack while providing enhanced ground contact, increased static friction, and decorative visual appeal is disclosed. The apparatus includes a load-bearing body having an upper member and an enlarged lower base configured to distribute loading from a jack post onto various ground surfaces. An upper receptacle positioned at the top of the load-bearing body defines a cavity that receives a lower portion of the jack post to transfer vertical loading and restrict lateral movement. In different embodiments, the load-bearing body is sculpted to resemble a human or animal leg and foot to provide stability and increased static friction, along with a stylistic or humorous appearance. In other embodiments, the apparatus includes an adjustable upper receptacle assembly having radially biased compression members that engage jack posts of varying diameters to ensure a secure fit.

### CROSS-REFERENCE TO RELATED APPLICATION

The present application claims priority to, and the benefit of, U.S. Provisional Application No. 63/785,048 which was filed on Apr. 8, 2025 and is incorporated herein by reference in its entirety.

### FIELD OF THE INVENTION

The present invention generally relates to support devices for trailer-mounted (i.e., mountable) jacks. More specifically, the present invention relates to a decorative and functional jack support apparatus configured to enhance the aesthetic appearance of a deployed trailer jack while simultaneously improving load distribution and stability. The invention comprises a multi-component structure that includes a load-bearing body having an upper member and a sculpted lower base portion shaped to resemble a human or ‘animal foot’ or other ornamental form. An upper receptacle positioned at the top of the load-bearing body defines a cavity dimensioned to receive and support a lower portion of a jack post, thereby transferring vertical loading into the apparatus while restricting lateral movement. In certain embodiments, the apparatus further includes structural enhancements such as an overload indicator or an adjustable receptacle assembly to ensure proper alignment, secure engagement, and safe operation during trailer support. Accordingly, the present disclosure makes specific reference thereto. Nonetheless, it is to be appreciated that aspects of the present invention are also equally applicable to other like applications, devices, and methods of manufacture.

### BACKGROUND

By way of background, trailer-mounted (i.e., mountable) jacks used on recreational vehicles (RVs), travel trailers, utility trailers, horse trailers, and similar towable equipment have commonly remained exposed during use. The jacks are generally constructed of metal and are designed for function, providing little or no consideration for visual appearance. When deployed, the jack often presents an industrial or unsightly appearance that detracts from the overall aesthetic of the vehicle or trailer.

Many users desire a more visually appealing presentation when their trailer is parked or displayed, particularly at campsites, events, or public gatherings. As a result, there is a growing interest in devices that can conceal or cover the exposed portion of the jack with an aesthetic or decorative feature. However, existing solutions may lack durability, stability, compatibility with standard jack posts, or the ability to enhance both appearance and functionality. Accordingly, people desire an improved jack support apparatus that provides structural stability while also enhancing the visual appearance of the deployed jack.

Therefore, there exists a long-felt need in the art for an improved trailer jack support apparatus that overcomes the limitations of conventional exposed metal jacks used on RVs, travel trailers, utility trailers, and horse trailers. There is a long-felt need for a support device that significantly enhances the visual appearance of a deployed jack, which is typically industrial, unsightly, and detracts from the aesthetic presentation of the trailer. Additionally, there exists a need for a jack support apparatus that enables users to decorate their jack with a fun and entertaining design. Moreover, there exists a need for a support system that improves ground stability and load distribution while simultaneously providing an ornamental structure that hides or masks the bare metal jack. Finally, there is a need in the art for a durable, structurally sound apparatus capable of safely supporting trailer loads while offering multiple decorative design options.

The subject matter disclosed and claimed herein, in one embodiment, comprises a trailer-mounted (i.e., mountable) jack support apparatus that combines functional load-bearing characteristics with an aesthetic or decorative exterior form. The apparatus includes a load-bearing body having an upper member and a lower base portion, with an upper receptacle defining a cavity configured to receive a lower portion of a trailer jack post. The cavity is sized to closely engage the jack post so that vertical loading is transferred directly into the load-bearing body while lateral movement is restricted. The load-bearing body may be sculpted, molded, carved, or otherwise formed to resemble a stylized human foot, ‘animal foot’, leg portion, or other thematic design. The lower base provides an enlarged ground-contact surface for enhanced traction and load distribution on loose, uneven, or granular terrain. The apparatus may be constructed from wood, metal, polymeric material, composite material, or combinations thereof to ensure suitable compressive strength, static friction force, and durability for supporting trailer loads.

In one embodiment, the jack support apparatus includes an overload indicator configured to provide a visual or tactile signal when a load applied through the jack post exceeds a predetermined threshold. The overload indicator may include a color-changing polymer layer, a strain-responsive film, or a mechanical indicator that deploys under excessive compression. In another embodiment, the apparatus includes an adjustable upper receptacle assembly having a plurality of radially biased compression members arranged circumferentially around an interior cavity. The apparatus can further include treaded or textured ground-contact features for increased static friction force between the jack support apparatus and the ground.

In this manner, the trailer-mounted (i.e., mountable) jack support apparatus of the present invention overcomes long-standing deficiencies in conventional jack stands by providing a structurally robust, visually appealing, and highly customizable support system. The invention enhances the aesthetic appearance of a deployed trailer jack, promotes improved stability, increases static friction and traction, and offers optional safety features such as overload indication and adjustable receptacle configurations. By combining functional performance with decorative versatility, the apparatus delivers enhanced user satisfaction, expanded personalization options, and improved compatibility with various trailer jack designs.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a trailer-mounted (i.e., mountable) jack support apparatus configured to support a trailer jack while improving stability and increasing friction. The apparatus includes a load-bearing body having an upper member and a lower end. An upper receptacle is positioned at the top of the upper member, and the receptacle defines a cavity that extends along at least a portion of the length of the upper member. The cavity is sized to receive a portion of a jack post so that load from the trailer jack is transmitted into the apparatus. The lower end of the load-bearing body forms an enlarged base surface that contacts the ground and distributes loading from the jack post to provide increased traction, friction, and improved stability on various types of terrain.

In another embodiment, a decorative jack support apparatus is provided in which the load-bearing body is sculpted, molded, carved, or otherwise formed to resemble a human or animal leg and foot. The load-bearing body includes an upper member and a lower end, and an upper receptacle is positioned near the top of the upper member. The receptacle defines a cavity that closely receives a lower portion of a jack post so that lateral movement of the jack post is restricted during use. The lower end of the load-bearing body is shaped to create an enlarged ground-contact surface that distributes load, increases static friction, and supports the trailer while providing a humorous or stylistic visual appearance.

In yet another embodiment, the invention provides a jack support apparatus capable of securing trailer jack posts of varying diameters. The apparatus includes a load-bearing body having an upper member and a lower base. An adjustable upper receptacle assembly is disposed at the upper end of the load-bearing body, and the assembly defines an interior cavity sized to receive a jack post. A plurality of radially biased compression members are arranged around the cavity. The compression members deflect inward when the jack post is inserted, enabling the apparatus to engage jack posts of different sizes while maintaining a secure grip and reducing lateral movement.

In still another embodiment, the jack support apparatus also includes an overload indicator positioned on the load-bearing body. The overload indicator is designed to provide a visual or tactile signal when a load applied through the jack post exceeds a predetermined safe threshold.

In some embodiments, the lower end of the load-bearing body is shaped in the form of an ‘animal foot’. The ‘animal-foot’ configuration may include multiple claw-like toes and a textured exterior surface. The features not only contribute to the decorative appearance of the apparatus but also enhance traction, increase friction, and improve stability on loose or uneven ground.

In yet another embodiment, the load-bearing body is formed from at least one structural material selected from wood, metal, polymeric materials, composite materials, or combinations thereof. The materials are selected to such that the apparatus possesses adequate compressive strength to support static or dynamic loads associated with trailer operation. The material selection enables the apparatus to withstand outdoor conditions while maintaining structural integrity during repeated use.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of trailer-mounted (i.e., mountable) jack support apparatus of the present invention in accordance with the disclosed structure;

FIG. 2 illustrates a perspective view showing the trailer-mounted (i.e., mountable) jack support apparatus in use with a trailer jack assembly in accordance with the disclosed structure;

FIG. 3 illustrates another embodiment of the trailer-mounted (i.e., mountable) jack support apparatus of the present invention in accordance with the disclosed structure; and

FIG. 4 illustrates an embodiment of the jack support apparatus incorporating an adjustable upper receptacle configured to secure a jack post of varying diameters in accordance with the disclosed structure.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an improved trailer jack support apparatus that overcomes the limitations of conventional exposed metal jacks used on RVs, travel trailers, utility trailers, and horse trailers. There is a long-felt need for a support device that significantly enhances the visual appearance of a deployed jack, which is typically industrial, unsightly, and detracts from the aesthetic presentation of the trailer. Additionally, there exists a need for a jack support apparatus that enables users to decorate their jack with a fun and entertaining design. Moreover, there exists a need for a support system that improves ground stability, increases friction, and load distribution while simultaneously providing an ornamental structure that hides or masks the bare metal jack. Finally, there is a need in the art for a durable, structurally sound apparatus capable of safely supporting trailer loads while offering multiple decorative design options.

The present invention, in one exemplary embodiment, is a decorative jack support apparatus in which the load-bearing body is sculpted, molded, carved, or otherwise formed to resemble a human or animal leg and foot. The load-bearing body includes an upper member and a lower end, and an upper receptacle is positioned near the top of the upper member. The receptacle defines a cavity that closely receives a lower portion of a jack post so that lateral movement of the jack post is restricted during use. The lower end of the load-bearing body is shaped to create an enlarged ground-contact surface that distributes load, increases friction, and supports the trailer while providing a humorous or stylistic visual appearance.

Reference will now be made in detail to the present preferred embodiments of the invention, examples of which are illustrated in the accompanying drawings. Wherever possible, the same reference numerals are used in the drawings and the description to refer to the same or like parts.

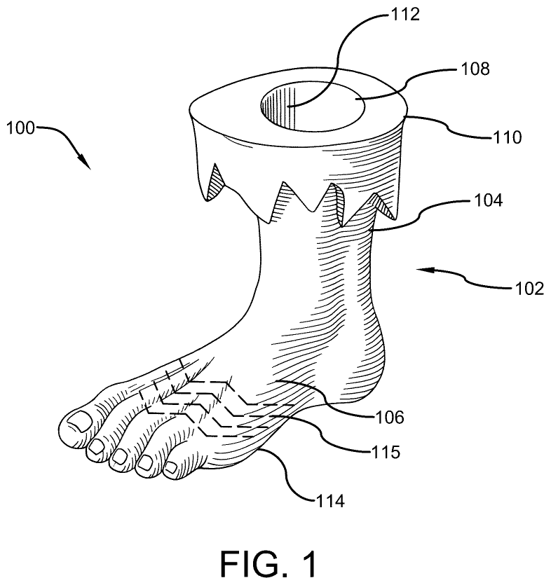

Referring initially to the drawings, FIG. 1 illustrates a perspective view of trailer-mounted (i.e., mountable) jack support apparatus of the present invention in accordance with the disclosed structure. The trailer-mounted (i.e., mountable) jack support apparatus 100 of the present invention is designed for use with RVs, travel trailers, utility trailers, horse trailers, and similar towable vehicles. The apparatus 100 serves as a stable base for a trailer jack while adding a functional, humorous, and stylistic visual element.

As shown, the apparatus 100 includes a load-bearing body 102 having an upper member 104 and a lower end 106. The load-bearing body 102 is sculpted, molded, carved, or otherwise formed to resemble a human or animal leg portion. An upper receptacle 108 is disposed at a top end 110 of the upper member 104. The upper receptacle 108 defines a cavity 112 extending along at least a portion of the length of the upper member 104. The cavity 112 is dimensioned to receive at least a portion of a jack post or jack tube of a trailer-mounted (i.e., mountable) jack.

The lower end 106 of the load-bearing body 102 forms a generally enlarged base surface 114 configured to increase ground contact area, enhance traction, increase static friction, and improve jack stability on loose, uneven, or granular terrain. The lower end 106 can be in the form to resemble a human or animal foot. The base surface 114 can further include a tread pattern, ridges, or textured ground-contact features 115 for increasing stability and traction of the apparatus 100.

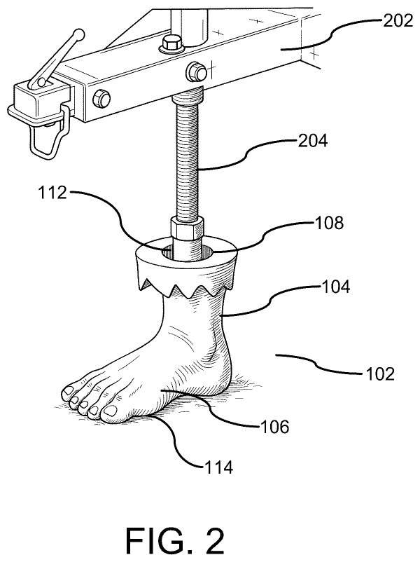

FIG. 2 illustrates a perspective view showing the trailer-mounted (i.e., mountable) jack support apparatus in use with a trailer jack assembly in accordance with the disclosed structure. As shown, a portion of a trailer frame 202 supports a trailer jack having a vertically oriented jack post 204. The lower end of the jack post 204 is received within the upper receptacle 108 of the load-bearing body 102. The upper receptacle 108 has the cavity 112 sized and shaped to closely and snugly (i.e., frictionally) receive the lower end of the jack post 204 such that the load from the trailer jack 202 is transferred directly into the load-bearing body 102. As depicted, the jack post 204 extends downward from the trailer frame 202 and fits snugly within the cavity 112 of the upper receptacle 108, thereby preventing lateral movement of the jack post relative to the load-bearing body 102 during use.

As illustrated in FIG. 1, the load-bearing body 102 is formed to resemble a stylized human leg and foot, although other decorative shapes may be used. The lower end 106 of the load-bearing body 102 forms the enlarged base 114 having a length greater than a width, configured to contact the ground surface and distribute loading from the jack post 204 to provide improved stability and traction, while increasing static friction on various ground surfaces or conditions.

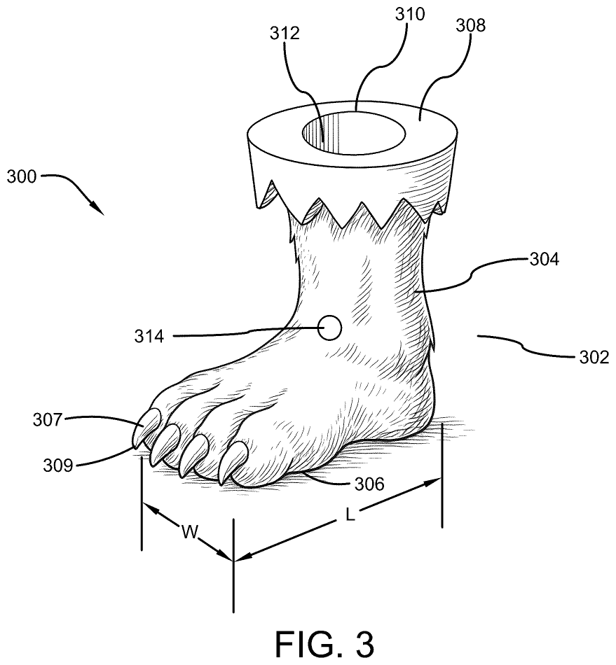

FIG. 3 illustrates another embodiment of the trailer-mounted (i.e., mountable) jack support apparatus of the present invention in accordance with the disclosed structure. In the present embodiment, the apparatus 300 includes a load-bearing body 302 having an upper member 304 and a lower end or base 306. The upper member 304 extends downward from a top region 308 that includes an upper receptacle 310. The upper receptacle 310 defines a cavity 312 sized and shaped to receive a lower portion of a trailer jack post in a manner similar to the embodiments shown in FIGS. 1 and 2, thereby enabling vertical loading from the trailer jack to be transferred through the load-bearing body 302.

As shown, the lower end 306 of the load-bearing body 302 is formed in the shape of an ‘animal foot’. In the illustrated embodiment, the base 306 includes multiple claw-like toes 307 and a stylized fur-textured exterior, providing a ‘snagging’ mechanism and a visually distinctive decorative appearance. The sculpted ‘animal-foot’ form serves both an aesthetic function and a structural function by providing an enlarged ground-contact area having a length greater than a width suitable for distributing the load of the trailer jack over a stable footprint and for increasing static friction forces. The claw-like toes 307 comprise pointed terminal ends 309 along a leading edge of the base 306 for ‘digging in’ or snagging the ground to resist movement and to increase static friction. In one embodiment the length (L) of the foot is greater than two times the width (W) of the foot. Further, in one exemplary embodiment the length of the foot is from 6 to 14 inches and the width of the foot is from 2 to 6 inches. The described embodiment results in a ground-contact area from 12 square inches to 84 square inches. In one preferred embodiment, the length of the foot is from 8 to 12 inches and the width of the foot is from 3 to 5 inches; comprising a ground-contact area from 24 square inches to 60 square inches. In another embodiment, the length of the foot is two-and-a-half times the width of the foot, wherein the length of the foot is from 9 to 12 inches and the width of the foot is from 3.6 to 4.8 inches. This embodiment results in a ground-contact area from 32.4 square inches to 57.6 square inches.

The load-bearing body 302 may be molded, sculpted, or otherwise formed from various structural materials as described previously, and the ‘animal-foot’ configuration shown in FIG. 3 represents only one example of the decorative configurations that may be used. The load-bearing body of different embodiments are formed from at least one structural material selected from the group consisting of wood, metal, polymeric material, composite material, and combinations thereof, the material(s) being chosen such that the apparatus possesses sufficient compressive strength to support at least a portion of the static or dynamic weight of the trailer.

The trailer-mounted (i.e., mountable) jack support apparatus 300 further includes an overload indicator 314 positioned on the load-bearing body 302. The overload indicator 314 is configured to provide a visual or tactile signal to the user when a predetermined load threshold applied through the jack post exceeds a safe operating limit for the apparatus 300. In the preferred embodiment, the overload indicator 314 may include a color-changing element, such as a pressure-responsive polymer layer, that transitions from a first color to a second contrasting color when subject to a load exceeding the predetermined threshold.

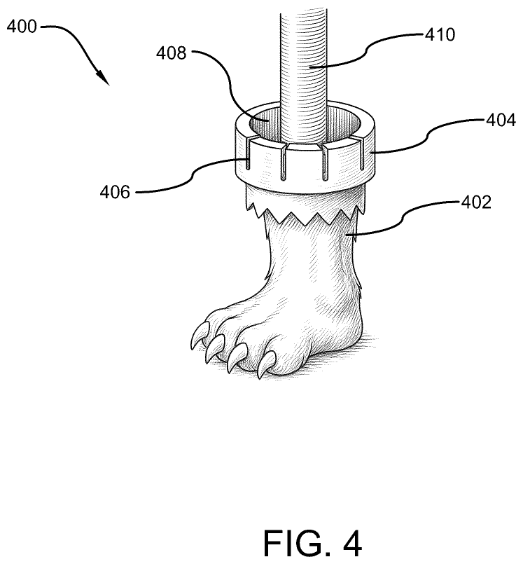

FIG. 4 illustrates an embodiment of the jack support apparatus incorporating an adjustable upper receptacle configured to secure a jack post of varying diameters in accordance with the disclosed structure. The decorative and functional jack support apparatus 400 includes a load-bearing body 402, which in the illustrated embodiment is formed to resemble an ‘animal foot’, similar to the embodiment shown in FIG. 3. The load-bearing body 402 supports an upper adjustable receptacle assembly 404 positioned at the upper end thereof.

The adjustable receptacle assembly 404 includes a plurality of radially biased compression members 406 arranged circumferentially around an interior cavity 408 sized to receive the lower end of a trailer jack post 410. The compression members 406 are configured to flex or deflect radially inward to grip the jack post when inserted, thereby accommodating jack posts of different diameters while maintaining a secure and stable fit. When the jack post is lowered into the adjustable receptacle assembly 404, the compression members 406 automatically engage the outer surface of the post through radial biasing, reducing lateral movement and enhancing overall stability of the supported trailer.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein, “decorative and functional jack support apparatus”, “trailer-mounted (i.e., mountable) jack support apparatus”, “trailer jack support apparatus”, and “apparatus” are interchangeable and refer to the decorative and functional jack support apparatus 100, 300, 400 of the present invention.

Notwithstanding the forgoing, the decorative and functional jack support apparatus 100, 300, 400 of the present invention can be of any suitable configuration as is known in the art without affecting the overall concept of the invention, provided that it accomplishes the above stated objectives. One of ordinary skill in the art will appreciate that the decorative and functional jack support apparatus 100, 300, 400 shown in the FIGS. are for illustrative purposes only, and that many other configurations of the decorative and functional jack support apparatus 100, 300, 400 are well within the scope of the present disclosure. Although the dimensions of the decorative and functional jack support apparatus 100, 300, 400 are important design parameters for user convenience, the decorative and functional jack support apparatus 100, 300, 400 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A trailer-mountable jack support comprising:
a load-bearing body comprising an upper member and a lower end; and
an upper receptacle;
wherein said upper receptacle is disposed at a top end of said upper member;
wherein said upper receptacle defines a cavity extending along at least a portion of a length of said upper member;
wherein said cavity is dimensioned to receive at least a portion of a jack post of a trailer-mounted jack;
wherein said lower end of said load-bearing body forms an enlarged base surface configured to increase ground contact area and static friction;
wherein said base surface comprising a length greater than two times a width of said base surface;
wherein a lower end of the jack post is received within said upper receptacle of said load-bearing body; and
further wherein said cavity comprising a shape to frictionally receive the lower end of the jack post such that a load from the trailer-mounted jack is transferred directly into said load-bearing body.

2. The trailer-mountable jack support of claim 1, wherein said length is from 6 to 14 inches and said width is from 2 to 6 inches, and further wherein said base surface comprising a ground-contact area from 12 square inches to 84 square inches.

3. The trailer-mountable jack support of claim 1, wherein said length is from 8 to 12 inches and said width is from 3 to 5 inches, further wherein said ground-contact area is from 24 square inches to 60 square inches.

4. The trailer-mountable jack support of claim 1, wherein said length is from 9 to 12 inches and said width is from 3.6 to 4.8 inches, further wherein said ground-contact area is from 32.4 square inches to 57.6 square inches.

5. The trailer-mountable jack support of claim 3, wherein said upper member of said load-bearing body is molded to resemble a leg portion.

6. The trailer-mountable jack support of claim 5, wherein said lower end of said load-bearing body is molded to resemble a foot portion.

7. The trailer-mountable jack support of claim 6, wherein said base surface comprises a tread pattern for increasing static friction between said base surface and the ground contact area.

8. The trailer-mountable jack support of claim 6, wherein said lower end comprising a plurality of claws along a leading edge, further wherein each of said plurality of claws comprising a pointed terminal end for snagging the ground contact area.

9. A trailer-mountable jack support comprising:
a load-bearing body comprising an upper member and a lower end; and
an upper receptacle;
wherein said upper receptacle is disposed at a top end of said upper member;
wherein said upper receptacle defines a cavity extending along at least a portion of a length of said upper member;
wherein said cavity is dimensioned to receive at least a portion of a jack post of a trailer-mounted jack;
wherein said lower end of said load-bearing body forms an enlarged base surface configured to increase ground contact area and static friction;
wherein said base surface comprising a length greater than two times a width of said base surface;
wherein a lower end of the jack post is received within said upper receptacle of said load-bearing body;
wherein said cavity comprising a shape to frictionally receive the lower end of the jack post such that a load from the trailer-mounted jack is transferred directly into said load-bearing body;
wherein said upper member of said load-bearing body is molded to resemble a leg portion;
wherein said lower end of said load-bearing body is molded to resemble a foot portion;
wherein said lower end comprising a plurality of claws along a leading edge; and
further wherein each of said plurality of claws comprising a pointed terminal end for snagging the ground contact area.

10. The trailer-mountable jack support of claim 9, wherein said length is from 6 to 14 inches and said width is from 2 to 6 inches, further wherein said base surface comprising a ground-contact area from 12 square inches to 84 square inches.

11. The trailer-mountable jack support of claim 9, wherein said length is from 8 to 12 inches and said width is from 3 to 5 inches, further wherein said ground-contact area is from 24 square inches to 60 square inches.

12. The trailer-mountable jack support of claim 9, wherein said length is from 9 to 12 inches and said width is from 3.6 to 4.8 inches, further wherein said ground-contact area is from 32.4 square inches to 57.6 square inches.

13. The trailer-mountable jack support of claim 11, wherein said base surface comprises a tread pattern for increasing static friction between said base surface and the ground contact area.

14. A trailer-mountable jack support comprising:
a load-bearing body comprising an upper member and a lower end; and
an adjustable upper receptacle;
wherein said upper receptacle is disposed at a top end of said upper member;
wherein said upper receptacle defines a cavity extending along at least a portion of a length of said upper member;
wherein said cavity is dimensioned to receive at least a portion of a jack post of a trailer-mounted jack;
wherein said lower end of said load-bearing body forms an enlarged base surface configured to increase ground contact area and static friction;
wherein said base surface comprising a length greater than two times a width of said base surface;
wherein a lower end of the jack post is received within said upper receptacle of said load-bearing body;
wherein said cavity comprising a shape to frictionally receive the lower end of the jack post such that a load from the trailer-mounted jack is transferred directly into said load-bearing body; and
further wherein said adjustable upper receptacle comprising a plurality of radially biased compression members configured to secure jack posts of varying diameters.

15. The trailer-mountable jack support of claim 14, wherein said length is from 8 to 12 inches and said width is from 3 to 5 inches, further wherein said ground-contact area is from 24 square inches to 60 square inches.

16. The trailer-mountable jack support of claim 15, wherein said upper member of said load-bearing body is molded to resemble a leg portion.

17. The trailer-mountable jack support of claim 16, wherein said lower end of said load-bearing body is molded to resemble a foot portion.

18. The trailer-mountable jack support of claim 17, wherein said base surface comprises a tread pattern for increasing static friction between said base surface and the ground contact area.

19. The trailer-mountable jack support of claim 18, wherein said lower end comprising a plurality of claws along a leading edge, further wherein each of said plurality of claws comprising a pointed terminal end for snagging the ground contact area.

20. The trailer-mountable jack support of claim 15 further comprising an overload indicator positioned on said load-bearing body, wherein said overload indicator is configured to provide a visual signal to the user when a predetermined load threshold applied through the jack post exceeds a safe operating limit for the jack support.
